(19) United States
(12) Patent Application Publication
(10) Pub. No.: US 2012/0066871 A1
(43) Pub. Date: Mar. 22, 2012

(54) Band Clamp With Temporary Band Securing Features

(75) Inventors: Michael Collins Daley, Lakewood, CO (US); Brian Minter, Aurora, CO (US); Christopher Newth, Farmington Hills, MI (US)

(73) Assignee: BAND-IT-IDEX, INC., Denver, CO (US)

(21) Appl. No.: 13/237,338

(22) Filed: Sep. 20, 2011

Related U.S. Application Data
(60) Provisional application No. 61/384,642, filed on Sep. 20, 2010.

(51) Int. Cl. B65D 63/00; G09F 3/02

(52) U.S. Cl. 24/16 R; 40/299.01

(57) ABSTRACT

A band clamp having a buckle for receiving a free end for binding various objects is provided wherein the band includes a mechanism for indicating an excess portion of the band needed for engagement with a tensioning tool. The mechanism may also facilitate temporary interconnection between the band and the buckle before tensioning.

This application claims the benefit of U.S. Patent Application Ser. No. 61/384,642, filed Sep. 20, 2010, the entire disclosure of which is incorporated by reference herein. This application is also related to U.S. patent application Ser. No. 12/628,943, filed Dec. 1, 2009, which is incorporated by reference in its entirety. This application is also related to U.S. Pat. No. 4,896,402, which stems from U.S. patent application Ser. No. 07/279,576, filed Dec. 2, 1988, which is a continuation-in-part of abandoned U.S. patent application Ser. No. 07/152,909, filed Feb. 5, 1988, the entire disclosures of which are incorporated by reference herein.

### FIELD OF THE INVENTION

Embodiments of the present invention are generally related to a fastening or clamping device and, in particular, to a band clamp comprising a band and a buckle for securing various objects.

### BACKGROUND OF THE INVENTION

Band clamps and cable ties (hereinafter “band clamps”) generally comprise a band having a first, free end, and a second end which has an integrated buckle for securing the band. One of skill in the art will appreciate that the buckle is also sometimes referred to as a seal or hood. In addition, the band is also sometimes referred to as a body or a strap. As band clamps are often stored in a coiled configuration, they can retain a curled shape which can create issues when the band is wrapped around objects having a diameter less than the curvature of the curled band. That is, a curled band will often recoil to its static or at rest position before it can be secured to the buckle, which can render fastening the band clamp more difficult.

Recoil can also reduce the amount of band material available to be fed into a tensioning tool even in the event the free end of the band is positioned within the buckle. More specifically, in order for a tensioning tool to engage a band, tools must receive and engage a sufficient amount of the band that protrudes from the buckle before tensioning and securement to the buckle may be accomplished. If the band recoils, the amount of band extending from the buckle will decrease and the tool may not be able to obtain a proper grip on the band. Thus, ensuring that the proper or sufficient amount of excess exists helps the user to engage the band into the tool.

Some prior art bands may include an indicator that is drawn or stamped onto the band that indicates the proper amount of free end of the band required by the tensioning tool. When the free end of the band is aligned with the indicator the operator will know that a sufficient length of the band extends for engagement by the tool. However, even when such indicators are present they can sometimes be obscured by dirt or other debris thus making them less effective.

Thus there is a long felt need to provide a band that provides a more distinct indication of excess band length required by the tensioning tool. The following disclosure describes various methods of providing and indicating the proper amount of band excess extending from the buckle. Some embodiments also employ an enhanced indicator that helps the operator maintain a proper amount of band excess before a tensioning tool is engaged onto the band clamp.

### SUMMARY OF THE INVENTION

It is one aspect of the present invention to provide a band with an excess length indicator in the form of an impression that may extend the width of the band. More specifically, one embodiment of the present invention employs a groove formed across the width of the band. After the band is wrapped about around an item or items, the free end is inserted into the buckle. A groove spaced from a leading edge of the free end of the band will indicate that the proper excess is provided. The contemplated groove is identifiable visually and/or tactilely by the user even if obscured by debris.

Alternatively, a band of one embodiment has an offset or step that engages the trailing edge of the buckle to maintain the band in a wrapped configuration. The step also provides the proper free end length or excess required for insertion into the tensioning tool. Other embodiments of the present invention provide a protrusion extending from the outer surface of the band to indicate proper excess band length. The protrusion may comprise a dimple pressed into the band and extending from the underside of the band or may be adhered or affixed to the outer surface of the band. Still other embodiments of the present invention include a tab that extends upwardly from the outer surface of the band to provide the contemplated protrusion. The tab may be formed by punching through the band. Other embodiments of the present invention employ a band with a widened or thickened portion that defines the required amount of excess needed.

Another embodiment of the present invention employs a deflected, i.e., kinked tail that facilitates threading of the free end into the buckle. The kinked portion of the band also identifies the excess length required for the tensioning tool.

It is another aspect of embodiments of the present invention to provide a band clamp having a band with a tapered free end that facilitates insertion of the free end into the buckle.

It is another aspect of embodiments of the present invention to provide a tail length indicator that is resistant to debris, so that it will be easily identifiable. More specifically, another embodiment of the present invention provide a band having a knurled or textured portion that indicates the proper band excess length. The knurled portion may be located on either or both the upperside and/or the underside of the band.

It will be expressly recognized that various features described herein may be provided in combination with additional features. That is, the inclusion of a particular indicator, for example, does not imply the exclusion of any other described above. It is contemplated that the band employs various combinations of indicators (e.g. protrusions as well as impressions).

It is another aspect of the present invention to provide a band clamp comprising: a band having a first end and a second end, an underside and an outerside; a buckle interconnected to the second end of the band, the buckle having an opening for receiving the first end of the band; and the band comprising a surface feature extending substantially along the width of the band on at least one of the underside and the outerside, the surface feature being positions closer to the first end than the second end, and the distance between the first end and the surface feature equals the amount of the band needed to interface with a tool.

It is yet another aspect of the present invention to provide a band clamp, comprising: a band having a first end and a second end and having a first lateral edge and a second lateral edge extending between the first end and the second end, the first edge and the second edge defining a first plane; a buckle integrally formed with the band at the second end of the band, the buckle including a first wall portion extending from the first edge of the band and a second wall portion extended from the second edge of the band, the buckle further including a third wall portion extending between the first and second wall potions, the third wall portion being offset from the first plane, thereby defining a slot for receiving the first end of the band; and wherein the band comprises visual indicia for relaying to an operation that first end of the band is passed sufficiently through the buckle.

Bands of the present invention are preferably constructed of 304 stainless steel. However, materials such as steel, aluminum, stainless steel alloys (316, 201, etc.), Titanium, Zeron, Monel, Inconel, Hastelloy, and similar materials or alloys thereof may be used without departing from the scope of the invention.

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1A is a top plan view of a prior art band clamp;

FIG. 1B is a front elevation view of FIG. 1;

FIG. 2A is a top plan view of the band clamp of one embodiment of the present invention that employs an impression to indicate proper tail length;

FIG. 2B is a front elevation view of FIG. 2A;

FIG. 2C is a cross sectional view showing the band clamp of FIG. 2A wrapped around an object;

FIG. 3A is a top plan view of a band clamp of one embodiment of the present invention that employs a step that helps maintain a wrapped configuration of a band and functions as a tail length indicator;

FIG. 3B is a front elevation view of FIG. 3A;

FIG. 3C is a cross sectional view showing the band clamp of FIG. 3 wrapped around an object;

FIG. 4A is a top plan view of another embodiment of the present invention that employs a protrusion that helps maintain a wrapped configuration of a band and functions as a tail length indicator;

FIG. 4B is a front elevation view of FIG. 4A;

FIG. 5A is a top plan view of another embodiment of the present invention that employs a band of inconsistent thickness that helps maintain a wrapped configuration of a band and functions as a tail length indicator;

FIG. 5B is a front elevation view of FIG. 5A;

FIG. 6A is a top plan view another embodiment of the present invention that employs a band of inconsistent width that helps maintain a wrapped configuration of a band and functions as a tail length indicator;

FIG. 6B is a front elevation view of FIG. 6A;

FIG. 7A is a top plan view of another embodiment of the present invention that employs a tab that helps maintain a wrapped configuration of a band and functions as a tail length indicator;

FIG. 7B is a front elevation view of FIG. 7A;

FIG. 8A is a top plan view of another embodiment of the present invention that employs a deflected tail that functions as a tail length indicator;

FIG. 8B is a front elevation view of FIG. 8A;

FIG. 9A is a front elevation view of another embodiment of the present invention that employs a knurled portion that functions as a tail length indicator;

FIG. 9B is a bottom plan view of FIG. 9A;

FIG. 10A is a top plan view of another embodiment of the present invention that employs a knurled or textured portion that functions as a tail length indicator;

FIG. 10B is a front elevation view of FIG. 10A;

FIG. 10C shows the band clamp of FIG. 10A wrapped around an object and prior to tensioning where an insufficient or non-ideal amount of excess extends from the buckle;

FIG. 10D shows the band clamp of FIG. 10A wrapped around an object and prior to tensioning having the correct amount of excess extending from the buckle;

FIG. 11 is a top plan view of a band according to one embodiment having a tapered end; and

FIG. 12 is a detailed view of FIG. 11.

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

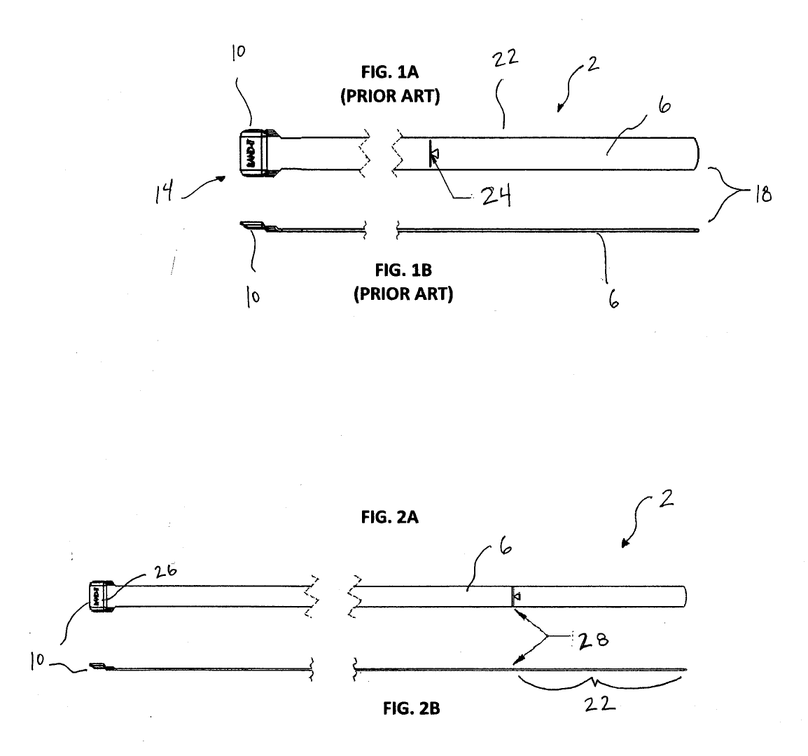

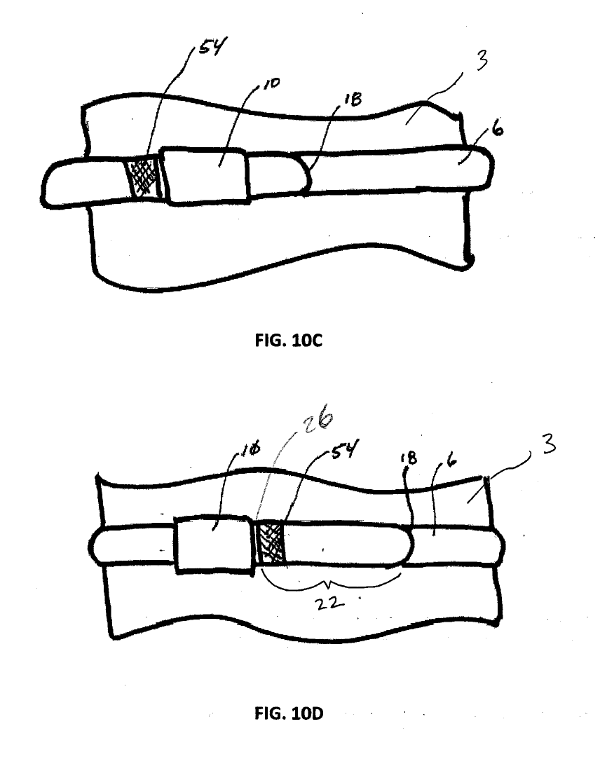

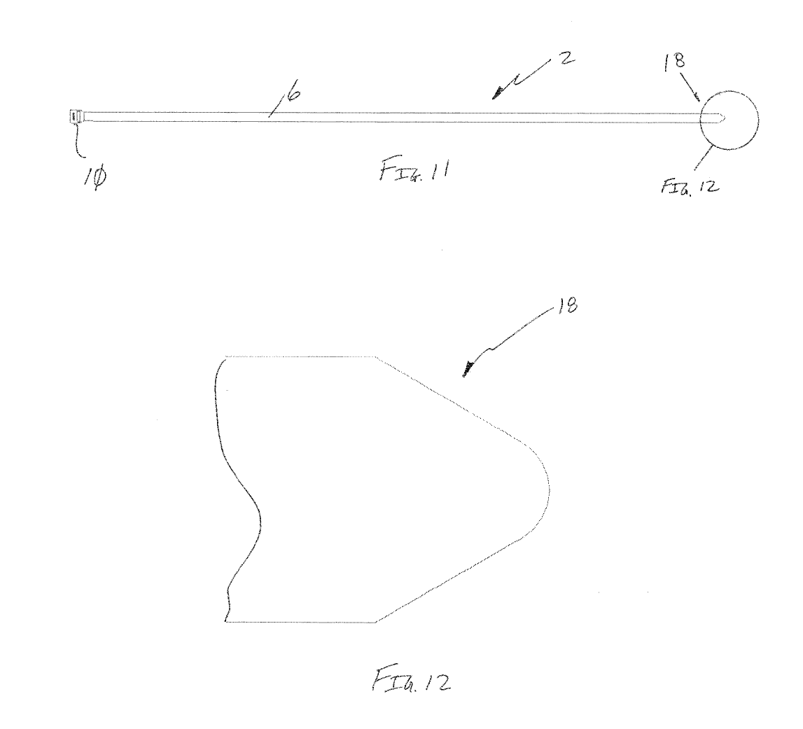

Referring now to FIGS. 1A and 1B, a prior art band clamp 2 is shown that includes a band 6 having a first end 18 and second end 14. A buckle 10 is interconnected to the second end 14 of the band 6. The band is wrapped around one or more objects and the first, free end 18 of the band 6 is inserted through buckle 10. Depending on the application, the band 6 may be threaded through the buckle 10 multiple times. A portion of the band 6 will thus extend from the buckle 10 to define an excess band portion 22 (FIGS. 10C and 10D) that is grasped or otherwise interconnected to a tensioning tool. The band 6 also includes a tail length indicator 24 which helps ensure that sufficient length extends beyond the buckle such that the tool may properly grasp the band.

The tensioning tool receives the excess portion 22 of the band 6 and applies tension to the band 6 to tighten the band about the wrapped object(s). After a predetermined amount of tension is achieved, the excess portion 22 of the band 6 is removed. Before cutting the excess from the band, however, a portion of the band may be curled over the buckle 10 to maintain the applied tension and to secure the band relative to the buckle. One drawback of the prior art band clamps is that the tail length indicator, which is comprised of a laser etch or printed indicia, may be hard to see. A further limitation of prior art band clamps is that they do not provide means for securing or partially securing the band in a pre-tensioned state, which leads to issues created by band recoil.

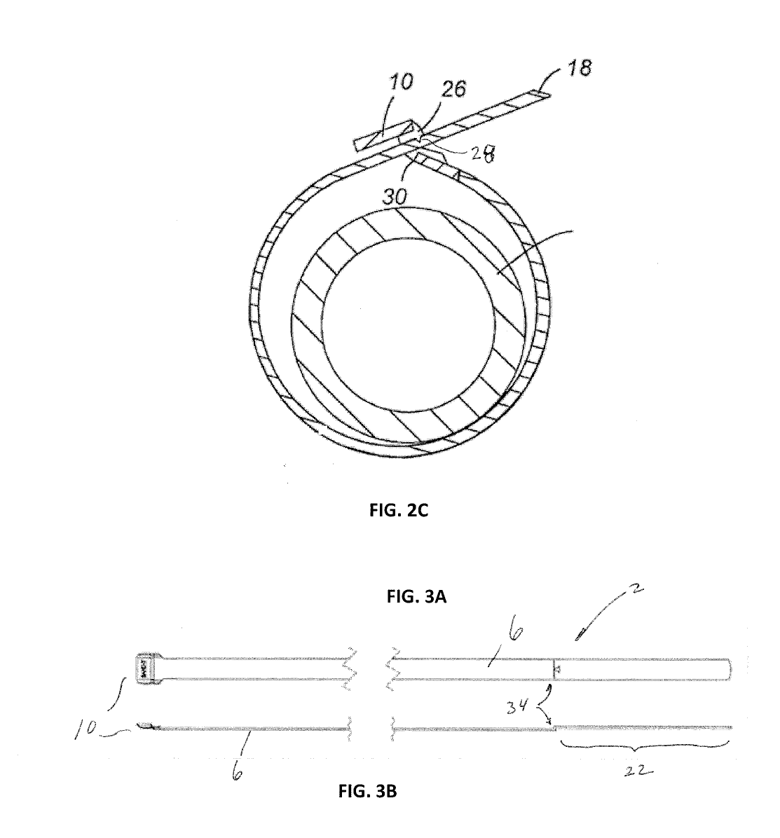

FIGS. 2A-2C depict one embodiment or the present invention wherein an impression 28 is used to indicated excess length. The impressions 28 may be formed at least on an outer surface of the band by a variety of known devices and methods including, but not limited to, etching or stamping. The impression is deeper than the etched mark employed by the band clamps of the prior art. The impression 28 may also extend the entire width of the band. The impression 28 further provides a more precise indication that the required amount of excess 22 has been achieved.

In some applications, the band's 6 tendency to recoil may cause the impression 28 to engage onto a trailing edge 26 of the buckle, thereby helping prevent unintentional release of the free end from the buckle before the tensioning tool is engaged. That is, after the band 6 is threaded through the buckle 10, the impression 28 will ideally abut the trailing edge 26 of the buckle 10, thereby holding the band 6 in place before tensioning. This is a capability that is dependent on the depth of the impression 28. One of skill in the art will recognize that the band clamp's 2 ability to resist recoil will greatly enhance the ease with which the band clamp is applied, particularly when working in confined spaces.

FIG. 2C is a cross sectional view showing the band clamp 2 positioned around an object 34 before tensioning. Here, the band clamp 2 is placed through the buckle 10 wherein the impression 28 in some instances will engage the trailing edge 26 of the buckle 10. The impression 28 provides visual and tactile indication of the appropriate excess 22. In an alternative embodiment, an impression 28 is provided on an underside or interior of the band 2, in addition to or in lieu of an impression 28 provided on an outerside. An impression 28 on an interior of the band could also engage a corresponding leading edge 30 of the band.

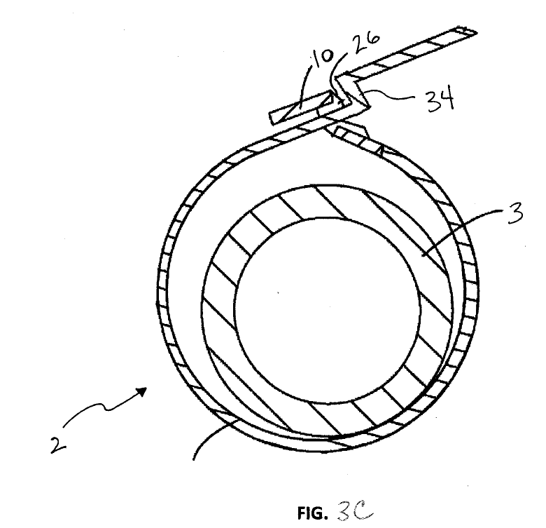

FIGS. 3A and 3B depict a band 6 having a step 34. Step 34 comprises a crimp, offset, or undulation in the otherwise continuous band that provides both a visual and tactile indication that an appropriate amount of band excess 22 is positioned beyond the buckle 10. The step 34 also may assist in maintaining the band 6 in a desired tool engagement position. More specifically, as shown in FIG. 3D, before tensioning, the step 34 of some embodiments will engage a trailing edge 26 of the buckle to maintain a pretension position on the band 6.

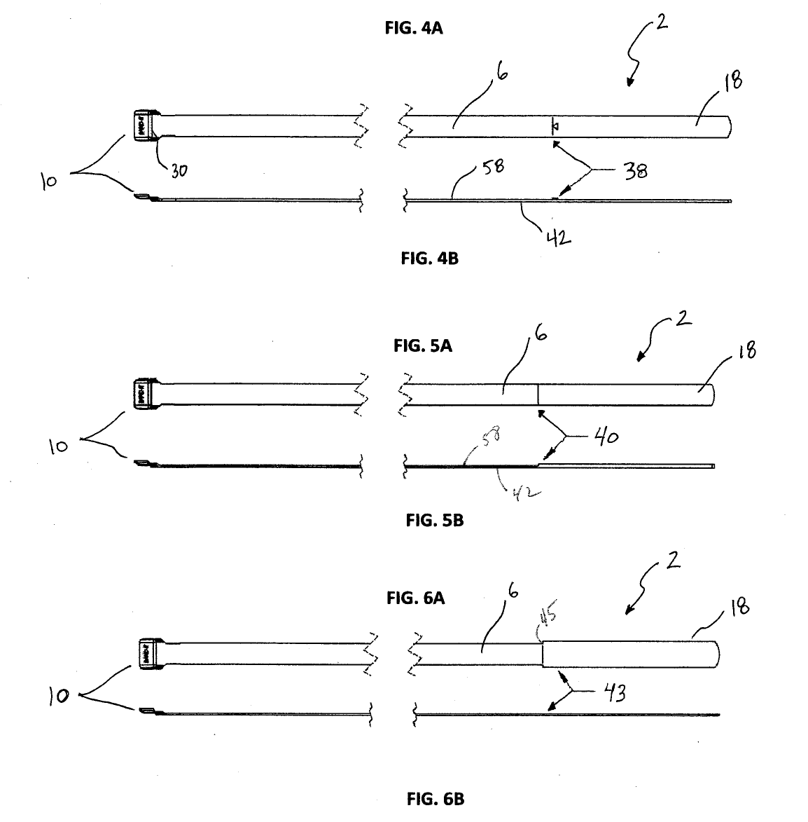

FIGS. 4A and 4B depict a band 6 having a protrusion 38. The protrusion 38 may be a dimple, stamp, spur, barb, etc. formed, machined, or adhered to the underside 42 or outerside 58 of the band 6. In various embodiments, the protrusion 38 is sized to allow for transition of the band 6 and protrusion 38 through an aperture in the buckle 10, yet prevent reverse movement as the protrusion 38 will engage the trailing edge 30 of the buckle 10. In addition, recoil caused by band memory shape may enhance the ability of the protrusion to engage the buckle in a pretension, intermediate state. The protrusion also provides a visual and tactile indication of proper excess band length.

FIGS. 5A and 5B depict a band 6 having a protrusion defined by a thickness change 40 in the band 6. Thickness change 40 may extend from the outer side 58 or inside 42 of the band. The thickness change 40 provides functionality similar to the step 34 described above. Once placed through the buckle 10, the protrusion provided by the thickness change 40 will engage the trailing edge 30 of the buckle 10 to maintain the shape of the band before tensioning. Again, memory shape and recoil may enhance this capability. The thickness change also indicates that an appropriate amount of excess has been provided.

FIGS. 6A and 6B provide a band 6 having a widened portion 43 which may extend from one or both lateral edges of the band 6. Once threaded into the buckle 10, the widened portion 43 will indicate that an appropriate amount of excess has been provided. In one embodiment, a width change 43 is provided such that the free end 18 of the band 6 must be manipulated (e.g. rotated) in order to fit through an aperture in the buckle 10. That is, in at least one embodiment the free end 18 of the band 6 is wider than the lateral dimension, but not the diagonal dimension, of the aperture provided by the buckle 10 that receives the free end of the band. Thus the band must be manipulated to be threaded through the buckle 10. Once the widened portion 43 has passed through the buckle, the band 6 is returned to its unmanipulated state wherein shoulders 45 formed at the junction of the widened portion and the narrow portion prevents release of the band relative to the buckle 10 in one direction, i.e., free end release due to recoil is prevented.

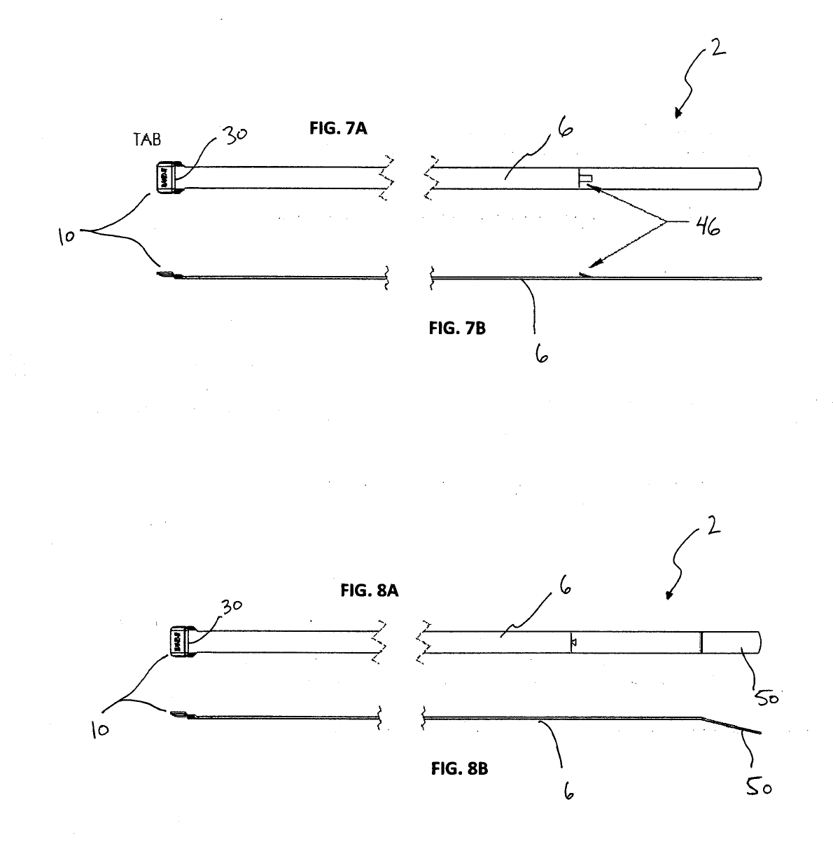

FIG. 7A and 7B depict a band 6 having a tab 46 for engagement with the trailing edge 30 of the buckle 10. Tab 46 comprises a resilient tongue that allows for translation of the band 6 through the buckle 10 in one direction, but which substantially limits travel of the band 6 through the buckle 10 in an opposite direction. In one embodiment, tab 46 is punched through the band 6. In operation, the free end 18 of the band 6 is fed through the buckle 10. Subsequently, when the band 6 relaxes, tab 46 engages the trailing edge 30 of the buckle 10, thereby positioning the predetermined amount of band excess needed by the tool.

FIGS. 8A and 8B depict a band 6 having a deflected or kinked tail 50 that facilitates threading of the band 6 into the buckle 10. In one embodiment, the kinked tail 50 comprises a downward kink, such that when the band 6 is wrapped around an object, the distal end of the band 6 is angled towards the buckle 10, thereby facilitating insertion of the free end into the buckle.

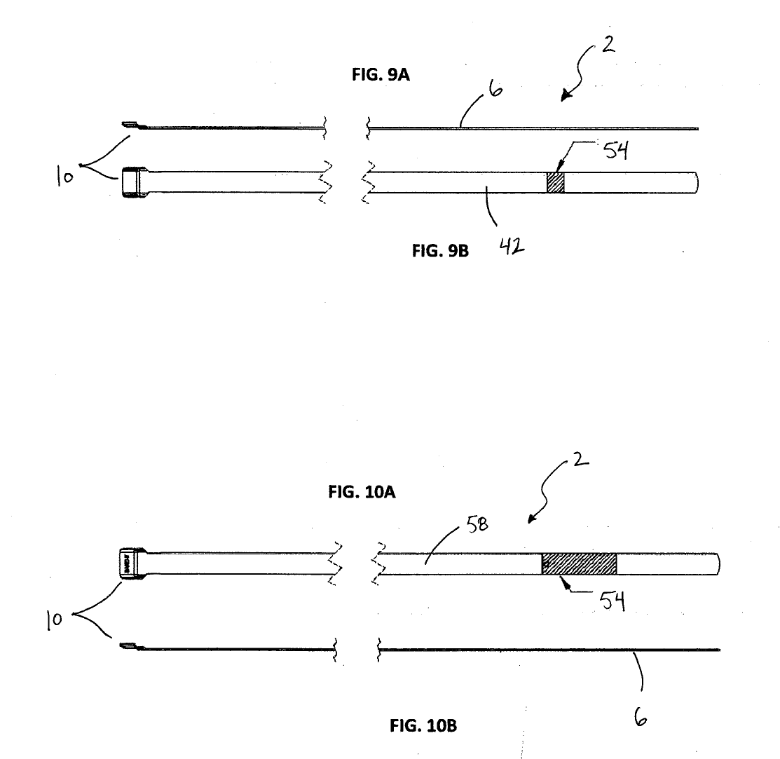

FIGS. 9A, 9B, 10A, and 10B depict bands 6 of particular embodiments with a knurled portion 54. In the embodiment shown in FIGS. 9A and 9B, the knurled portion 54 is located on the underside 42 of the band, which helps indicate to the operator that the proper amount of band excess 22 is positioned outside the buckle 10. The knurled portion 54 may provide tactile or visual indication of the tail length. The knurled portion 54 of FIGS. 10A and 10B is located on the outerside 58 of the band which indicates the proper amount of excess 22 positioned outside the buckle 10. Additionally, the knurled portion 54 will interact with the trailing edge of the buckle 10 to help maintain the band 6 in the correct position. As previously stated, various features disclosed herein may be provided in combination. Specifically, for example, knurled portions may be provided on both the underside and outerside of the band 6.

FIGS. 10C and 10D show the band 6 having a knurled portion about an object 3 with insufficient band excess beyond the buckle (FIG. 10C) and with sufficient excess band extending beyond the buckle (FIG. 10D). More specifically, FIG. 10C shows the indicator 54 outside of the buckle 10, which indicates that an incorrect amount of excess is present. Conversely, FIG. 10D shows that the second end 18 of the band clamp 2 has been pulled sufficiently through the buckle 10 which positions the knurled portion 54 near the trailing edge 26 of the buckle. The user would be able to see and/or feel the knurled portion and know that the proper amount of excess 22 has been provided.

FIGS. 11-12 depict an embodiment wherein the free end 18 of the band 6 comprises a tapered arrangement. Here, the free end 18 may be tapered on one or both edges. The degree of taper and angle thereof may vary. The taper facilitates insertion of the second end 18 into the buckle.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

What is claimed is:

1. A band clamp comprising:
a band having a first end and a second end, an underside and an outerside;
a buckle interconnected to said second end of said band, said buckle having an opening for receiving said first end of said band; and
said band comprising a surface feature extending substantially along the width of said band on at least one of said underside and said outerside, said surface feature being positions closer to said first end than said second end, and the distance between said first end and said surface feature equals the amount of the band needed to interface with a tool.

2. The band clamp of claim 1 wherein said band is predisposed to be generally flat such that when said first end and said surface feature are placed through said buckle, said surface feature is engaged against a trailing edge of said buckle.

3. The band clamp of claim 1, wherein a surface feature is provided on said underside and said outerside of said band.

4. The band clamp of claim 1, wherein said surface feature comprises at least one of an indentation, a mark, a step, a protrusion, a knurled surface, a rasp, a band width change, and a band thickness change.

5. The band clamp of claim 1, wherein said first end comprises a taper.

6. The band clamp of claim 1, wherein said first end comprises a kink.

7. A band clamp, comprising:
a band having a first end and a second end and having a first lateral edge and a second lateral edge extending between said first end and said second end, said first edge and said second edge defining a first plane;
a buckle integrally formed with said band at said second end of said band, said buckle including a first wall portion extending from said first edge of said band and a second wall portion extended from said second edge of said band, said buckle further including a third wall portion extending between said first and second wall potions, said third wall portion being offset from said first plane, thereby defining a slot for receiving said first end of said band; and
wherein said band comprises visual indicia for relaying to an operation that first end of said band is passed sufficiently through said buckle.

8. The band clamp of claim 7, wherein said indicia further comprises a means for contacting said third wall portion.

9. The band clamp of claim 7, wherein said indicia comprises an indentation on at least one side of said band.

10. The band clamp of claim 7, wherein said first wall portion and said second wall portion are angled outwardly such that said opening is wider adjacent to said third wall portion of said buckle than the distance between said first edge and said second edge.

11. The band clamp of claim 7, wherein said indicia comprises at least one of an indentation, a mark, a step, a protrusion, a knurled surface, a rasp, a band width change band, and a band thickness change.
